(19) United States
(12) Patent Application Publication
(10) Pub. No.: US 2024/0248208 A1
(43) Pub. Date: Jul. 25, 2024

(54) DISTANCE MEASURING APPARATUS

(71) Applicant: Sharp Semiconductor Innovation Corporation, Tenri City (JP)

(72) Inventors: Tetsuro IKEDA, Tenri City (JP); Takahiro INOUE, Tenri City (JP); Hideki SATO, Tenri City (JP); Takayuki SHIMIZU, Tenri City (JP); Isamu KAWABE, Tenri City (JP)

(21) Appl. No.: 18/416,687

(22) Filed: Jan. 18, 2024

(30) Foreign Application Priority Data
Jan. 19, 2023 (JP) 2023-006824

(51) Int. Cl. G01S 17/10; G01S 7/4865

(52) U.S. Cl. CPC G01S 17/10; G01S 7/4865

(57) ABSTRACT

A distance measuring apparatus includes: a light-emitting portion that transmits a plurality of light-emitting pulse signals corresponding to a plurality of pulsed light beams; an object light-receiving portion that transmits a plurality of object pulse signals corresponding to a plurality of object pulsed light beams; a time-to-digital converter that converts a light-emitting timing of the plurality of light-emitting pulse signals and an object light-receiving timing of the plurality of object pulse signals into digital values; and a histogram-generating-and-distance-calculating unit that generates an object histogram that has a horizontal axis representing a difference between the digital value of the object light-receiving timing and the digital value of the light-emitting timing and that calculates a distance to the distance-measurement object, based on a center of gravity of the object histogram, wherein the light-emitting portion emits the plurality of pulsed light beams at a random interval corresponding to a uniform random number.

### CROSS-REFERENCE TO RELATED APPLICATION

The present application claims priority from Japanese Application JP2023-006824 filed on Jan. 19, 2023, the content to which is hereby incorporated by reference into this application.

### BACKGROUND OF THE INVENTION

### 1. Field of the Invention

The present disclosure relates to a distance measuring apparatus.

### 2. Description of the Related Art

In recent years, a distance measuring apparatus that includes a time-of-light (ToF) sensor has been developed as disclosed in Japanese Unexamined Patent Application Publication No. 2020-144025. The distance measuring apparatus calculates a distance from an object by multiplying a time until pulsed light that is emitted from a light-emitting portion is reflected by the object and is received by a light-receiving portion by the speed of light.

In the case where a short distance is measured, the distance from the distance measuring apparatus to a distance-measurement object is calculated based on the center of gravity of a histogram of a plurality of pulsed light beams in order to improve the accuracy of distance measurement. As for the measurement, in some cases where the period of emission of the plurality of pulsed light beams decreases, the reflected light of the first pulsed light beam is received from a non-distance-measurement object that is farther than the distance-measurement object after the second pulsed light beam is emitted.

In this case, the distance from the distance measuring apparatus to the distance-measurement object is calculated based on a difference in time between the center of gravity of the histogram of the reflected light of the second pulsed light from the distance-measurement object and the center of gravity of the histogram of the reflected light of the first pulsed light from the non-distance-measurement object. For this reason, the distance to the distance-measurement object is not accurately calculated.

The present disclosure has been accomplished in view of the above problems. It is desirable to provide a distance measuring apparatus that can inhibit a distance to an object from being mistakenly measured.

### SUMMARY OF THE INVENTION

According to an aspect of the disclosure, there is provided a distance measuring apparatus including a light-emitting portion that emits a plurality of pulsed light beams and that transmits a plurality of light-emitting pulse signals corresponding to the plurality of pulsed light beams, an object light-receiving portion that receives a plurality of object pulsed light beams that are reflected by a distance-measurement object among the plurality of pulsed light beams and that transmits a plurality of object pulse signals corresponding to the plurality of object pulsed light beams, a time-to-digital converter that converts a light-emitting timing of the plurality of light-emitting pulse signals and an object light-receiving timing of the plurality of object pulse signals into digital values, and a histogram-generating-and-distance-calculating unit that generates an object histogram that has a horizontal axis representing a difference between the digital value of the object light-receiving timing and the digital value of the light-emitting timing and that calculates a distance to the distance-measurement object, based on a center of gravity of the object histogram. The light-emitting portion emits the plurality of pulsed light beams at a random interval corresponding to a uniform random number.

### BRIEF DESCRIPTION OF THE DRAWINGS

FIG. 1 schematically illustrates a functional block of a distance measuring apparatus according to a first embodiment;

FIG. 2 illustrates examples of light-emitting pulse signals and object pulse signals;

FIG. 3 illustrates an object histogram of object pulse signals corresponding to reflected light from a distance-measurement object and a non-object histogram of object pulse signals corresponding to reflected light from a non-distance-measurement object in the case where a random value is not set or is a fixed value;

FIG. 4 illustrates the object histogram of the object pulse signals corresponding to the reflected light from the distance-measurement object and the non-object histogram of the object pulse signals corresponding to the reflected light from the non-distance-measurement object in the case where the random value linearly increases;

FIG. 5 illustrates the object histogram of the object pulse signals corresponding to the reflected light from the distance-measurement object and the non-object histogram of the object pulse signals corresponding to the reflected light from the non-distance-measurement object in the case where the random value corresponds to a uniform random number;

FIG. 6 illustrates a timing chart, wherein part (a) of FIG. 6 illustrates a timing chart in the case where a counter that has poor differential nonlinearity is used, and no random value is used; Part (b) of FIG. 6 illustrates a timing chart in the case where the counter that has poor differential nonlinearity is used, and the random value is used;

FIG. 7 schematically illustrates a functional block of a distance measuring apparatus according to a second embodiment;

FIG. 8 illustrates a flowchart for describing the operation of the distance measuring apparatus according to the second embodiment;

FIG. 9 illustrates a timing chart for digital values and signals that are transmitted and received in the distance measuring apparatus according to the second embodiment;

FIG. 10 illustrates a reference histogram of reference pulse signals, the non-object histogram of non-object pulse signals, and the object histogram of the object pulse signals that are generated by the distance measuring apparatus according to the second embodiment;

FIG. 11 illustrates a structural diagram for describing a crosstalk component in a light-emitting pulse that is transmitted by the distance measuring apparatus according to the second embodiment; and

FIG. 12 illustrates a histogram for describing the digital values of object pulse signals corresponding to the crosstalk component in the light-emitting pulse that is transmitted by the distance measuring apparatus according to the second embodiment.

### DETAILED DESCRIPTION OF THE INVENTION

Distance measuring apparatuses according to embodiments of the present disclosure will hereinafter be described with reference to the drawings. As for the drawings, like or similar components are designated by like reference characters, and a duplicated description is not repeated.

### First Embodiment

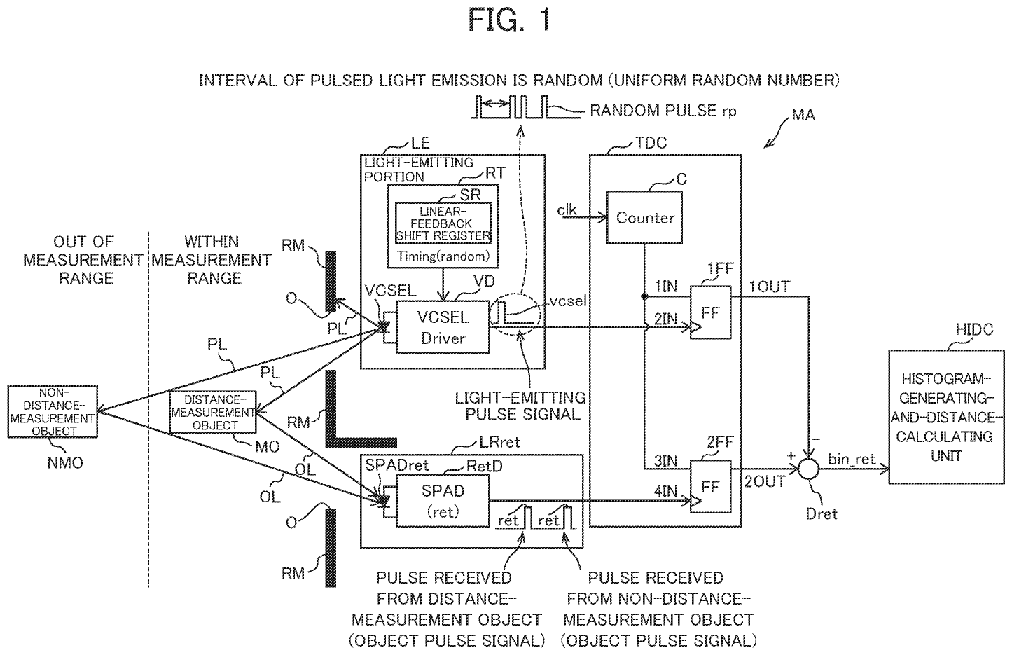

A distance measuring apparatus MA according to a first embodiment will be described with reference to FIG. 1 to FIG. 6. The distance measuring apparatus MA according to the present embodiment is used, for example, for detecting a collision between a robot cleaner and an obstacle. The distance measuring apparatus MA according to the present embodiment is used in the case where short distance measurement is frequently made.

FIG. 1 schematically illustrates a functional block of the distance measuring apparatus MA according to the embodiment.

As illustrated in FIG. 1, the distance measuring apparatus MA includes a light-emitting portion LE, a reflection member RM, an object light-receiving portion LRret, a time-to-digital converter TDC, an object subtraction circuit Dret, and a histogram-generating-and-distance-calculating unit HIDC. The time-to-digital converter TDC is typically referred to as a time to digital convertor.

The light-emitting portion LE includes a random pulse generation circuit RT, a light-emitting element VCSEL, and a transmission circuit VD. The light-emitting element VCSEL is typically referred to as a vertical cavity surface emitting laser.

The random pulse generation circuit RT is an electronic circuit that generates a plurality of random pulses rp at a random interval by using a clock signal that includes a plurality of pulse signals that are repeatedly transmitted at a regular interval. That is, the random pulse generation circuit RT sequentially outputs the random pulses rp with random timings.

A uniform random number is used to generate the random interval. The uniform random number means a random number in accordance with a probability distribution defined such that a numeral appears with the same probability in a section. For example, the uniform random number is generated by a linear-feedback shift register SR in the random pulse generation circuit RT.

The light-emitting element VCSEL emits a plurality of pulsed light beams PL corresponding to the plurality of random pulses rp at the random interval.

The transmission circuit VD transmits a plurality of light-emitting pulse signals vcsel corresponding to the plurality of pulsed light beams PL that are emitted by the light-emitting element VCSEL to the time-to-digital converter TDC described later. That is, the transmission circuit VD transmits the light-emitting pulse signals vcsel to the time-to-digital converter TDC with timings synchronized with timings with which the pulsed light beams PL are emitted from the light-emitting element VCSEL. Accordingly, the transmission circuit VD transmits the light-emitting pulse signals vcsel to the time-to-digital converter TDC at the random interval corresponding to the uniform random number.

The reflection member RM reflects the plurality of pulsed light beams PL that are emitted from the light-emitting portion LE. The reflection member RM has an opening O. The opening O allows the plurality of pulsed light beams PL that are emitted from the light-emitting element VCSEL to pass. Accordingly, the opening O restricts the direction in which the pulsed light beams PL travel. According to the present embodiment, however, the reflection member RM may not be included.

A distance-measurement object MO is near the distance measuring apparatus MA. In some cases, a non-distance-measurement object NMO is at a position farther than the distance-measurement object MO from the distance measuring apparatus MA. In this case, the plurality of pulsed light beams PL that are emitted from the light-emitting element VCSEL are reflected by the distance-measurement object MO and the non-distance-measurement object NMO. As for the distance-measurement object MO, a distance from a reference position to the distance-measurement object MO is to be measured. As for the non-distance-measurement object NMO, a distance is not to be measured.

The object light-receiving portion LRret includes an object light-receiving element SPADret and a transmission circuit RetD.

The object light-receiving element SPADret includes a light-receiving diode for conversion into a plurality of pulse signals depending on a plurality of pulsed light beams that are received. According to the present embodiment, the object light-receiving element SPADret includes a single photon avalanche diode. The object light-receiving element SPADret receives a plurality of object pulsed light beams OL that are reflected by the distance-measurement object MO and the non-distance-measurement object NMO among the plurality of pulsed light beams PL that are emitted from the light-emitting portion LE and that subsequently pass through the opening O.

The transmission circuit RetD transmits a plurality of object pulse signals ret corresponding to the plurality of object pulsed light beams OL that are received by the object light-receiving element SPADret. That is, the transmission circuit RetD transmits the object pulse signals ret with timings synchronized with timings with which the object light-receiving element SPADret receives the object pulsed light beams OL.

The time-to-digital converter TDC converts light-emitting timings of the plurality of light-emitting pulse signals vcsel and object light-receiving timings of the plurality of object pulse signals ret into digital values.

The time-to-digital converter TDC includes a dedicated electronic circuit and includes a counter C, a first flip flop circuit 1FF, and a second flip flop circuit 2FF.

The counter C receives a clock signal clk that includes a plurality of pulses that are transmitted from an oscillator (not illustrated) at a regular interval. The counter C sequentially outputs digital count values the number of which corresponds to the number of the pulses in the clock signal clk that is received. In the case of a hexadecimal number, for example, the counter C outputs the digital count values the number of which corresponds to a number of 1 to 16 and subsequently repeats an operation of outputting the digital count values corresponding to a number of 1 to 16 again.

The first flip flop circuit 1FF includes a first input terminal 1IN, a second input terminal 2IN, and a first output terminal 1OUT.

The first input terminal 1IN sequentially receives the digital count values that are outputted by the counter C. The second input terminal 2IN sequentially receives the plurality of light-emitting pulse signals vcsel that are outputted from the transmission circuit VD. The first output terminal 1OUT outputs, as the digital values of the light-emitting timings, the digital count values that are inputted into the first input terminal 1IN when the light-emitting pulse signals vcsel are inputted into the second input terminal 2IN.

The second flip flop circuit 2FF includes a third input terminal 3IN, a fourth input terminal 4IN, and a second output terminal 2OUT.

The third input terminal 3IN sequentially receives the digital count values that are outputted from the counter C. The fourth input terminal 4IN receives the plurality of object pulse signals ret that are outputted from the transmission circuit RetD. The second output terminal 2OUT outputs, as the digital values of the object light-receiving timings, the digital count values that are inputted into the third input terminal 3IN when the object pulse signals ret are inputted into the fourth input terminal 4IN.

The object subtraction circuit Dret calculates and outputs differences bin_ret between the digital values of the object light-receiving timings that are outputted from the second output terminal 2OUT and the digital values of the light-emitting timings that are outputted from the first output terminal 1OUT.

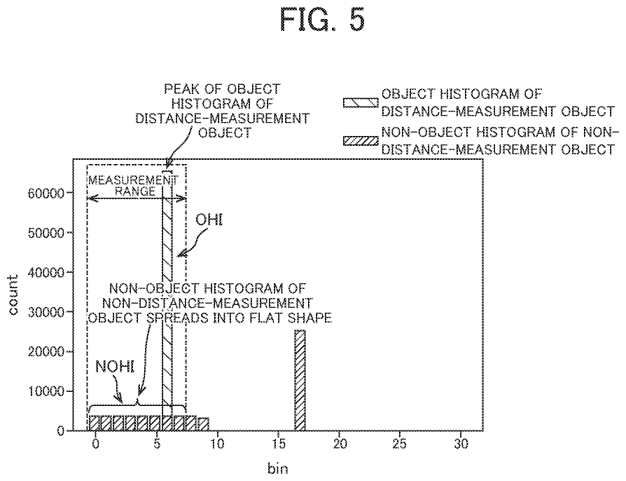

The histogram-generating-and-distance-calculating unit HIDC generates an object histogram OHI (see FIG. 5) that has a horizontal axis representing the differences bin_ret between the digital values of the object light-receiving timings and the digital values of the light-emitting timings. The histogram-generating-and-distance-calculating unit HIDC calculates a distance from a predetermined reference position to the distance-measurement object MO, based on the center of gravity of the object histogram OHI (see FIG. 5). More specifically, the histogram-generating-and-distance-calculating unit HIDC multiplies a difference between a reference time and a time for the center of gravity of the object histogram OHI (see FIG. 5) by the speed of light.

According to the present embodiment, the histogram-generating-and-distance-calculating unit HIDC includes a dedicated electronic circuit but may include a processor and a program that runs in the above manner based on the processor.

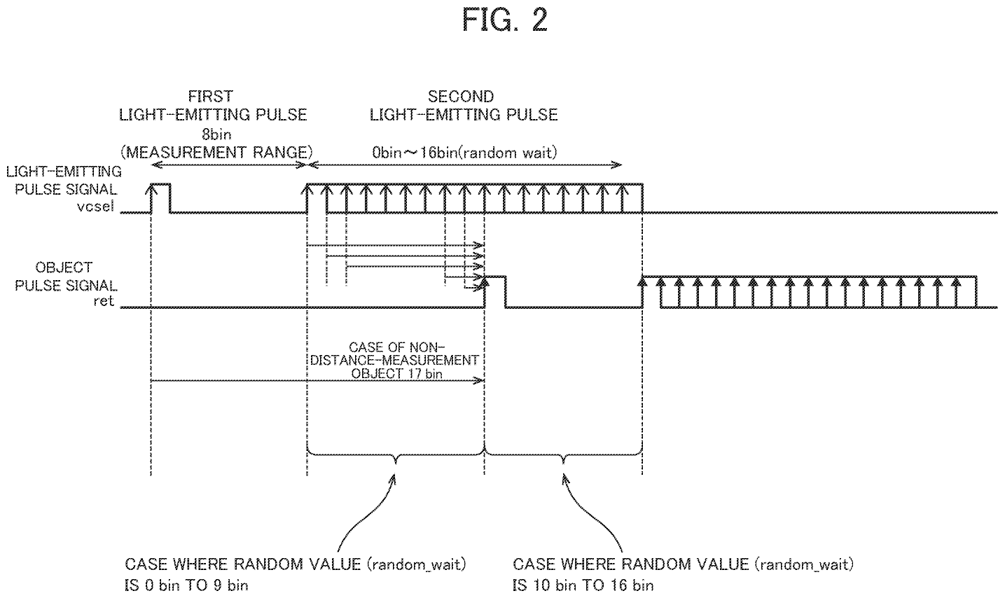

FIG. 2 illustrates examples of the light-emitting pulse signals vcsel and the object pulse signals ret.

In FIG. 2, a measurement range is 8 bin, a random value is 0 bin to 16 bin, and the timings of the light-emitting pulse signals vcsel and the object pulse signals ret in the case where the non-distance-measurement object NMO is at a position of 17 bin.

As for the pulsed light that is reflected by the non-distance-measurement object NMO in the case where the random value is 0 bin to 9 bin, the difference bin_ret between the second light-emitting pulse signal vcsel and the first object pulse signal ret is calculated as expressed as an expression (1):

difference bin_ret=17 bin−(start timing of second light-emitting pulse)=17 bin−8 bin-random_wait=9 bin−random.

As understood from the expression (1), a difference between a fixed value and a uniform random number is represented as “differences bin_ret =9 bin-random”, which is a uniform random number.

The probability of fulfilment of this condition is (17−8)/16=56.2%. Among all of the object pulse signals ret corresponding to all of the pulsed light beams that are reflected by the non-distance-measurement object NMO, 56.2% of object pulse signals spread in a range of 0 bin to 9 bin.

As for the pulsed light that is reflected by the non-distance-measurement object NMO in the case where the random value is 10 bin to 16 bin, the difference bin_ret between the first light-emitting pulse signal vcsel and the first object pulse signal ret is calculated as expressed as an expression (2):

difference bin_ret=17 bin−(start timing of first light-emitting pulse)=17 bin−0 bin=17 bin (this is a fixed value but is processed as a value out of the measurement range).

The probability of fulfilment of this condition is (16−(17−8))/16=43.7%. Accordingly, among all of the object pulse signals corresponding to all of the pulsed light beams that are reflected by the non-distance-measurement object NMO, 43.7% of object pulse signals are counted for 17 bin. Since 17 bin is a value out of the measurement range, a measurement value is not affected. The reason why 17 bin is out of the measurement range is that the measurement range is set to 8 bin according to the present embodiment. Accordingly, the differences bin_ret that are out of a range of 0 bin to 7 bin are not counted as the histogram, that is, are ignored. According to the present embodiment, the measurement range is set to 8 bin, but 8 bin is an example of the measurement range. In other words, the value of the measurement range can be appropriately set.

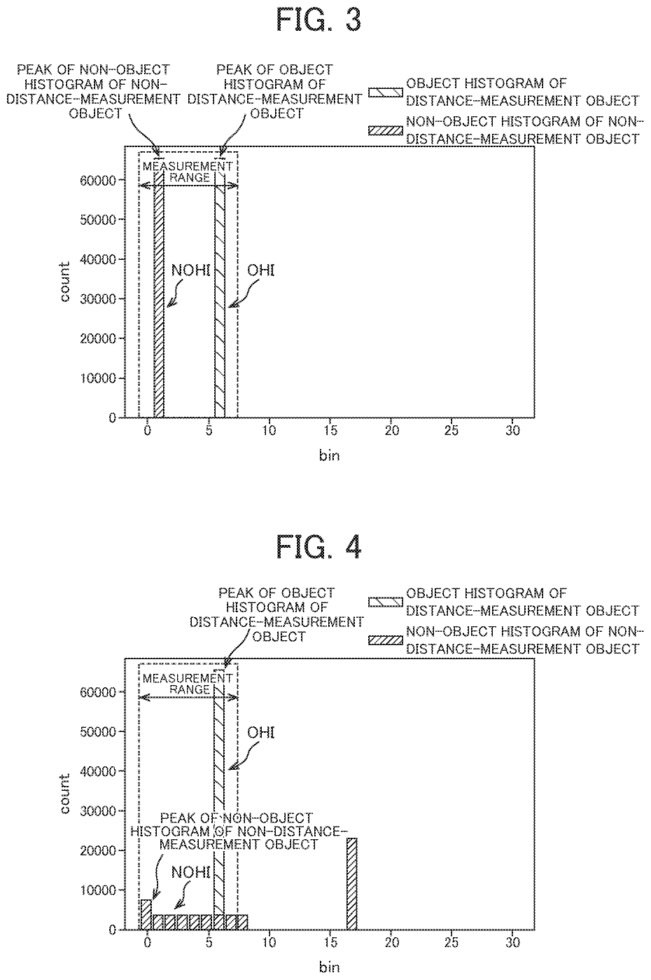

FIG. 3 illustrates the object histogram OHI of the object pulse signals ret corresponding to the reflected light from the distance-measurement object MO and the non-object histogram NOHI of the object pulse signals ret corresponding to the reflected light from the non-distance-measurement object NMO in the case where the random value is not set or is a fixed value.

In the case where the random value is not set or is a fixed value, as understood from FIG. 3, the non-object histogram NOHI is not flat but has a peak that is as high as the peak of the object histogram OHI. In this case, it is sometimes difficult to distinguish between the object histogram OHI of the distance-measurement object MO and the non-object histogram NOHI of the non-distance-measurement object NMO. For this reason, it is not easy to accurately calculate the center of gravity of the object histogram of the distance-measurement object MO in some cases. Accordingly, the distance to the distance-measurement object MO is not accurately measured in some cases.

FIG. 4 illustrates the object histogram OHI of the object pulse signals ret corresponding to the reflected light from the distance-measurement object MO and the non-object histogram NOHI of the object pulse signals ret corresponding to the reflected light from the non-distance-measurement object NMO in the case where the random value linearly increases.

In the case where the random value linearly increases, as understood from FIG. 4, the non-object histogram of the non-distance-measurement object NMO has a peak, and accordingly, a portion of the non-object histogram NOHI of the non-distance-measurement object NMO is not flat. For this reason, in some cases where the peak of the non-object histogram NOHI is as high as the peak of the object histogram OHI, it is difficult to distinguish between the object histogram OHI and the non-object histogram NOHI.

For example, the non-distance-measurement object NMO is a total-reflection mirror, and it is accordingly through that high intensity of the reflected light increases the level of the peak of the non-object histogram NOHI to the same level as the peak of the object histogram OHI. In this case, it is not easy to accurately calculate the center of gravity of the object histogram OHI. Accordingly, the distance from the reference position to the distance-measurement object MO is not accurately measured in some cases.

FIG. 5 illustrates the object histogram OHI of the object pulse signals ret corresponding to the reflected light from the distance-measurement object MO and the non-distance-measurement object histogram NOHI of the object pulse signals ret corresponding to the reflected light from the non-distance-measurement object NMO in the case where the random value corresponds to a uniform random number.

In FIG. 5, the non-object histogram NOHI of the plurality of object pulsed light beams OL that are reflected by the non-distance-measurement object NMO are compared with the object histogram OHI of the plurality of object pulsed light beams OL that are reflected by the distance-measurement object MO. In this case, as understood from FIG. 5, the non-object histogram NOHI is lower than the object histogram OHI as a whole and has a flat shape. That is, in the case where the random value (random_wait) is random, the non-object histogram spreads into a flat shape within the measurement range.

For this reason, the non-object histogram NOHI and the object histogram OHI can be easily distinguished. As a result, it is easy to accurately calculate the center of gravity of the object histogram OHI. Accordingly, the distance can be inhibited from being mistakenly measured also in the case of the short distance measurement. The reason is that the distance measuring apparatus MA according to the present embodiment emits the plurality of pulsed light beams PL at the random interval corresponding to the uniform random number as described above and that the non-object histogram NOHI is accordingly flat.

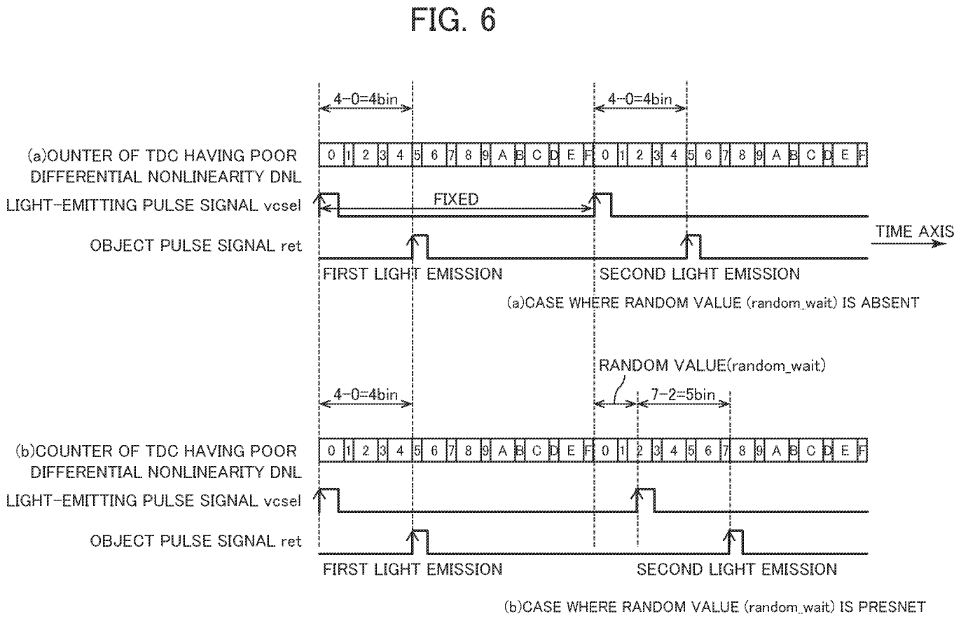

Part (a) of FIG. 6 illustrates a timing chart in the case where a counter that has poor differential nonlinearity is used, and no random value is used. Part (b) of FIG. 6 illustrates a timing chart in the case where the counter that has poor differential nonlinearity is used, and the random value is used. In part (a) of FIG. 6 and part (b) of FIG. 6, the lateral width of each of boxes in which numerals are illustrated corresponds to a histogram bin width.

As illustrated in part (b) of FIG. 6, the use of the random value enables the digital count values that are outputted by the counter C to be evenly used in a permissible range even in the case where the time-to-digital converter TDC has poor differential nonlinearity. For this reason, in the case of part (b) of FIG. 6, the digital count values are unlikely to be adversely affected due to the magnitude of the histogram bin width unlike the case of part (a) of FIG. 6.

Accordingly, the distance measuring apparatus MA according to the present embodiment enables the distortion of the shape of the object histogram OHI (see FIG. 5) that is caused by the differential nonlinearity of the time-to-digital converter TDC to be reduced. For this reason, an error in the center of gravity of the object histogram OHI can be inhibited from being made. Accordingly, the measurement of the distance from the predetermined reference position to the distance-measurement object MO can be inhibited from making an error.

### Second Embodiment

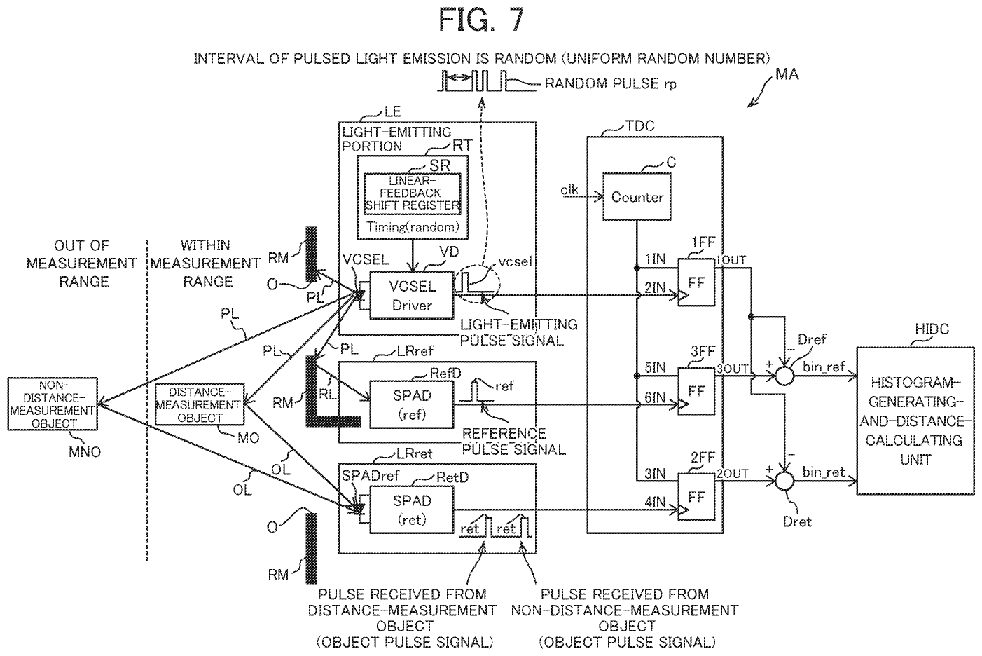

A distance measuring apparatus according to a second embodiment will be described with reference to FIG. 7 to FIG. 10. In the following description, the common matters to the distance measuring apparatus MA according to the first embodiment are not repeated. The distance measuring apparatus MA according to the present embodiment differs in matters described below from the distance measuring apparatus MA according to the first embodiment.

FIG. 7 schematically illustrates a functional block of the distance measuring apparatus MA according to the second embodiment.

As understood from FIG. 7, the distance measuring apparatus MA according to the present embodiment includes a reference light-receiving portion LRref in addition to the structure of the distance measuring apparatus MA according to the first embodiment. The reference light-receiving portion LRref includes a reference light-receiving element SPADref and a transmission circuit RefD.

The reference light-receiving element SPADref includes a light-receiving diode for conversion into a plurality of pulse signals depending on a plurality of pulsed light beams that are received. The reference light-receiving element SPADref receives a plurality of reference pulsed light beams RL that are reflected by the reflection member RM among the plurality of pulsed light beams PL.

The transmission circuit RefD transmits a plurality of reference pulse signals ref corresponding to the plurality of reference pulsed light beams RL that are received by the reference light-receiving element SPADref. That is, the transmission circuit RefD transmits the reference pulse signals ref with timings synchronized with timings with which the reference light-receiving element SPADref receives the plurality of reference pulsed light beams RL.

According to the present embodiment, the time-to-digital converter TDC converts the reference light-receiving timings of the plurality of reference pulse signals ref into digital values in addition to the light-emitting timings and the object light-receiving timings. For this reason, the time-to-digital converter TDC includes a third flip flop circuit 3FF in addition to the first flip flop circuit 1FF and the second flip flop circuit 2FF.

The third flip flop circuit 3FF includes a fifth input terminal 5IN, a sixth input terminal 6IN, and a third output terminal 3OUT.

The fifth input terminal 5IN sequentially receives the digital count values that are outputted from the counter C. The sixth input terminal 6IN sequentially receives the plurality of reference pulse signals ref that are transmitted from the transmission circuit RefD. The third output terminal 3OUT outputs, as the digital values of the reference light-receiving timings, the digital count values that are inputted into the fifth input terminal 5IN when the reference pulse signals ref are inputted into the sixth input terminal 6IN.

The distance measuring apparatus MA according to the present embodiment includes a reference subtraction circuit Dref in addition to the structure of the distance measuring apparatus MA according to the first embodiment.

The reference subtraction circuit Dref calculates and outputs differences bin_ref between the digital values of the reference light-receiving timings that are outputted from the third output terminal 3OUT and the digital values of the light-emitting timings that are outputted from the first output terminal 1OUT.

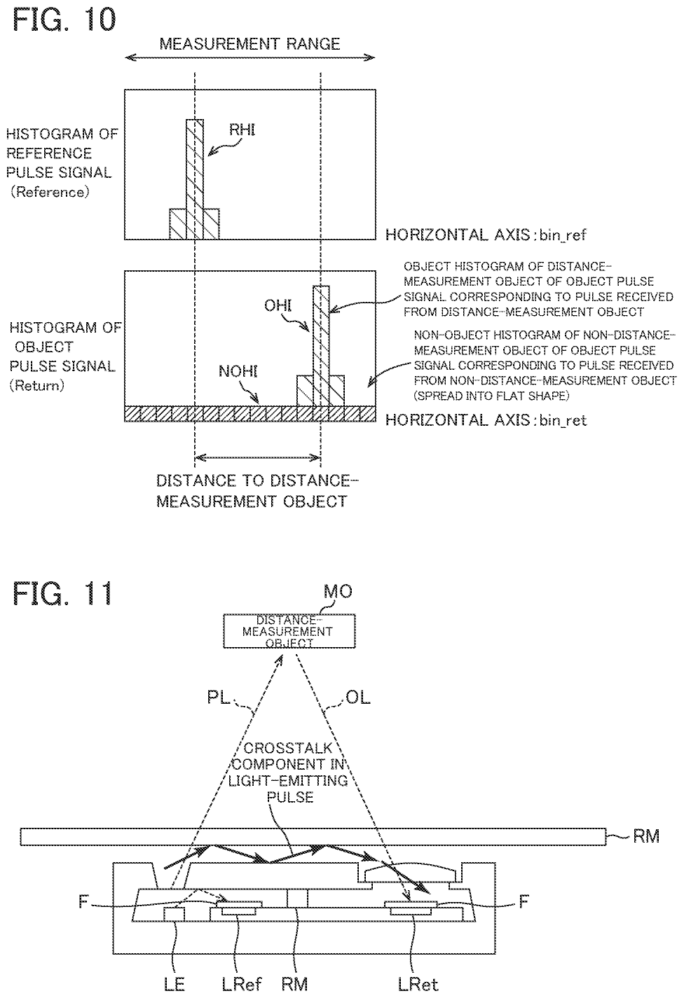

According to the present embodiment, the histogram-generating-and-distance-calculating unit HIDC generates a reference histogram RHI (see FIG. 10) that has a horizontal axis representing the differences bin_ref between the digital values of the reference light-receiving timings and the digital values of the light-emitting timings. As in the first embodiment, the histogram-generating-and-distance-calculating unit HIDC generates the object histogram OHI (see FIG. 10) that has the horizontal axis representing the differences bin_ret between the digital values of the object light-receiving timings and the digital values of the light-emitting timings.

The histogram-generating-and-distance-calculating unit HIDC calculates the distance from the predetermined reference position to the distance-measurement object MO, based on the difference between the center of gravity of the reference histogram RHI and the center of gravity of the object histogram OHI. More specifically, the histogram-generating-and-distance-calculating unit HIDC multiplies a difference in time that is specified by using the difference between the center of gravity of the reference histogram RHI and the center of gravity of the object histogram OHI by the speed of light and consequently calculates the distance from the reference position to the distance-measurement object MO.

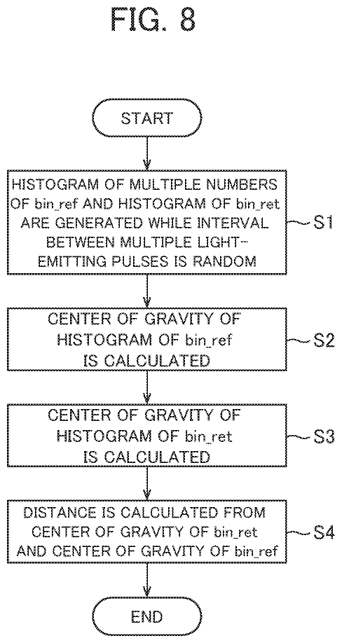

FIG. 8 illustrates a flowchart for describing the operation of the distance measuring apparatus MA according to the present embodiment.

As for the distance measuring apparatus MA according to the present embodiment, at a step S1, the light-emitting portion LE sequentially emits the plurality of pulsed light beams PL and generates the reference histogram RHI of the differences bin_ref and the object histogram OHI (see FIG. 10) of the differences bin_ret. Subsequently, at a step S2, the center of gravity of the reference histogram RHI of the differences bin_ref is calculated. Subsequently, at a step S3, the center of gravity of the object histogram OHI of the differences bin_ret is calculated. Subsequently, at a step S4, the distance from the predetermined reference position to the distance-measurement object MO is calculated from the difference between the center of gravity of the reference histogram RHI of differences bin_ref and the center of gravity of the object histogram OHI of the differences bin_ret.

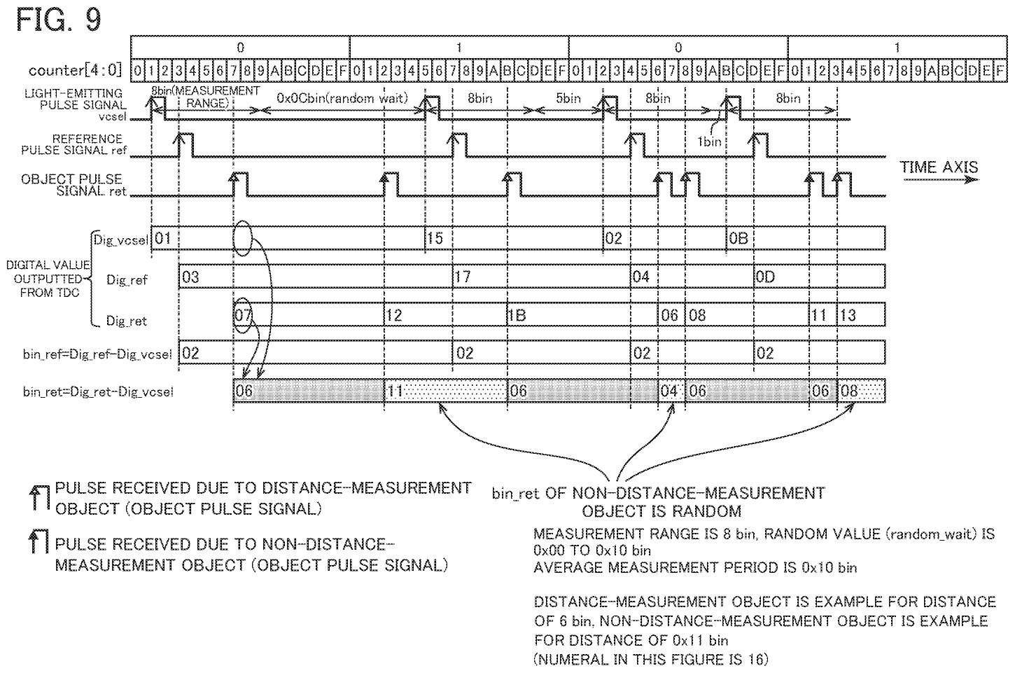

FIG. 9 illustrates a timing chart for the digital values and the signals that are transmitted and received in the distance measuring apparatus MA according to the embodiment.

As illustrated in FIG. 9, the light-emitting portion LE transmits the light-emitting pulse signals vcsel to the first flip flop circuit 1FF with random timings as described according to the first embodiment. According to the present embodiment, the light-emitting pulse signals vcsel are generated based on 8 bin and the random value (random_wait). The first flip flop circuit 1FF receives the digital count values that are outputted by the counter C, based on the clock signal clk. The first flip flop circuit 1FF sequentially outputs digital values Dig_vcsel, such as “01”, “15”, “02”, and “0B”, of the timings with which the light-emitting pulse signals vcsel are received.

The reference light-receiving element SPADref transmits the reference pulse signals ref to the third flip flop circuit 3FF. The third flip flop circuit 3FF receives the digital count values that are outputted by the counter C, based on the clock signal clk. Consequently, the third flip flop circuit 3FF outputs digital values Dig_ref, such as “03”, “17”, “04”, and “0D”, of the timings with which the reference pulse signals ref are received.

The object light-receiving portion LRret transmits two object pulse signals ret to the second flip flop circuit 2FF.

The preceding object pulse signal ret of the two object pulse signals ret that are adjacent to each other on a time axis in FIG. 9 corresponds to the object pulsed light beam OL that is reflected by the distance-measurement object MO. The succeeding object pulse signal ret of the two object pulse signals ret that are adjacent to each other on the time axis in FIG. 9 corresponds to the object pulsed light beam OL that is reflected by the non-distance-measurement object NMO.

The second flip flop circuit 2FF receives the digital count values that are outputted by the counter C, based on the clock signal. Consequently, the second flip flop circuit 2FF outputs the digital values Dig_ref, such as “07”, “12”, “1B”, “06”, “08”, “11”, and “13”, of the timings with which the object pulse signals ret are received.

The reference subtraction circuit Dref calculates the differences bin_ref between the digital count values Dig_ref of the reference light-receiving timings of the reference pulse signals ref and the digital count values Dig_vcsel of the light-emitting timings of the light-emitting pulse signals vcsel. The differences bin_ref are fixed values such as “02”.

The object subtraction circuit Dret calculates the differences bin_ret between the digital count values Dig_ref of the object light-receiving timings of the object pulse signals ret and the digital count values Dig_vcsel of the light-emitting timings of the light-emitting pulse signals vcsel. The differences bin_ret are uniformly distributed random values such as “0F”, “04”, and “03”.

FIG. 10 illustrates the reference histogram RHI of the reference pulse signals ref, the non-object histogram NOHI of the object pulse signals ret, and the object histogram OHI of the object pulse signals ret that are generated by the distance measuring apparatus MA according to the embodiment.

As illustrated in FIG. 10, the reference histogram RHI of the differences bin_ref represents a distribution that is concentratedly illustrated on a substantially one place. As for the differences bin_ret, however, a partial distribution that is concentratedly illustrated on a substantially one place is represented, and a partial uniform distribution that is illustrated so as to spread into a flat shape is represented.

The center of gravity of the reference histogram RHI of the differences bin_ref and the center of gravity of the object histogram OHI of the differences bin_ret illustrated in FIG. 10 can be calculated. Accordingly, a difference between the center of gravity of the object histogram OHI of the differences bin_ret and the center of gravity of the reference histogram RHI of the differences bin_ref can be calculated.

The distance measuring apparatus MA according to the present embodiment emits the plurality of pulsed light beams PL at the random interval corresponding to the uniform random number.

For this reason, as illustrated in FIG. 10, the non-object histogram NOHI is lower than the object histogram OHI as a whole and has a flat shape. Accordingly, the distance measuring apparatus MA according to the present embodiment enables the distance to be inhibited from being mistakenly measured in the case of the short distance measurement as in the distance measuring apparatus MA according to the first embodiment.

The distance measuring apparatus MA according to the present embodiment enables the distortion of the shape of the object histogram OHI that is caused by the differential nonlinearity of the time-to-digital converter TDC to be reduced as in the distance measuring apparatus MA according to the first embodiment.

The distance measuring apparatus MA according to the present embodiment can obtain the following effects in addition to the effects that are obtained by the distance measuring apparatus MA according to the first embodiment.

The use of the difference between the center of gravity of the object histogram OHI of the differences bin_ret and the center of gravity of the reference histogram of the differences bin_ref enables the delay time of light emission of the light-emitting element VCSEL to be canceled.

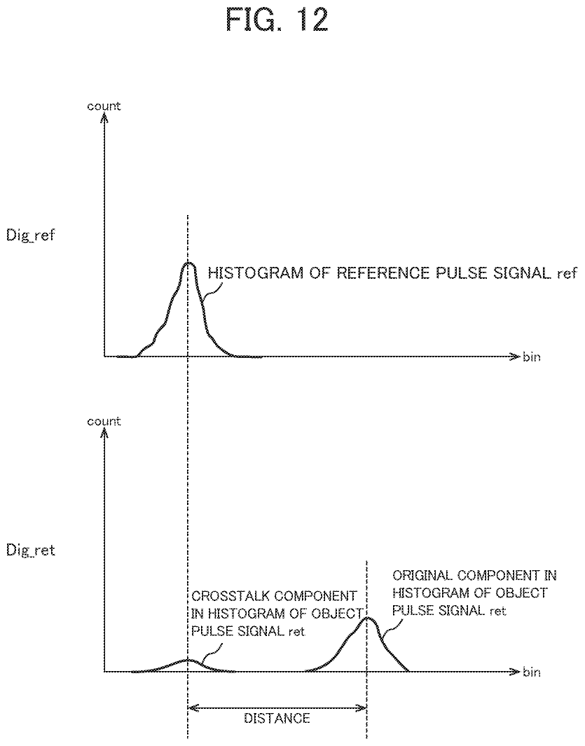

FIG. 11 illustrates a structural diagram for describing a crosstalk component in a light-emitting pulse of the distance measuring apparatus MA according to the second embodiment. FIG. 12 illustrates histograms for describing the digital values of object pulse signals ret corresponding to the crosstalk component in the pulsed light of the distance measuring apparatus MA according to the second embodiment.

As for the light-emitting pulse that is reflected by the reflection member RM illustrated in FIG. 11, as illustrated in FIG. 12, the histogram of the object pulse signals ret corresponding to the crosstalk component and the histogram of the object pulse signals ret of the original component thereof can be distinguished. The distance measuring apparatus MA according to the present embodiment calculates the distance to the distance-measurement object MO by using the difference between the center of gravity of the object histogram OHI of the differences bin_ret and the center of gravity of the reference histogram of the differences bin_ref as described above. For this reason, an error in the distance to the distance-measurement object MO to be calculated can be inhibited from being made by the object pulse signals ret corresponding to the crosstalk component described above.

While there have been described what are at present considered to be certain embodiments of the invention, it will be understood that various modifications may be made thereto, and it is intended that the appended claim cover all such modifications as fall within the true spirit and scope of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A distance measuring apparatus comprising:
a light-emitting portion that emits a plurality of pulsed light beams and that transmits a plurality of light-emitting pulse signals corresponding to the plurality of pulsed light beams;
an object light-receiving portion that receives a plurality of object pulsed light beams that are reflected by a distance-measurement object among the a plurality of pulsed light beams and that transmits a plurality of object pulse signals corresponding to the plurality of object pulsed light beams;
a time-to-digital converter that converts a light-emitting timing of the plurality of light-emitting pulse signals and an object light-receiving timing of the plurality of object pulse signals into digital values; and
a histogram-generating-and-distance-calculating unit that generates an object histogram that has a horizontal axis representing a difference between the digital value of the object light-receiving timing and the digital value of the light-emitting timing and that calculates a distance to the distance-measurement object, based on a center of gravity of the object histogram, wherein the light-emitting portion emits the plurality of pulsed light beams at a random interval corresponding to a uniform random number.

2. The distance measuring apparatus according to claim 1, further comprising:
a reflection member; and
a reference light-receiving portion that receives a plurality of reference pulsed light beams that are reflected by the reflection member among the plurality of pulsed light beams and that transmits a plurality of reference pulse signals corresponding to the plurality of reference pulsed light beams, wherein the time-to-digital converter converts a reference light-receiving timing of the plurality of reference pulse signals into a digital value, and wherein the histogram-generating-and-distance-calculating unit generates a reference histogram that has a horizontal axis representing a difference between the digital value of the reference light-receiving timing and the digital value of the light-emitting timing and calculates the distance to the distance-measurement object, based on a difference between a center of gravity of the reference histogram and the center of gravity of the object histogram.

3. The distance measuring apparatus according to claim 1, wherein the light-emitting portion includes a linear-feedback shift register that generates the uniform random number.

4. The distance measuring apparatus according to claim 1, wherein the object light-receiving portion transmits the plurality of object pulse signals corresponding to the plurality of object pulsed light beams that are reflected by a non-distance-measurement object that differs from the distance-measurement object among the plurality of pulsed light beams, wherein the histogram-generating-and-distance-calculating unit generates a non-object histogram that has a horizontal axis representing a difference between a digital value of a reference light-receiving timing and the digital value of the object light-receiving timing of the plurality of object pulsed light beams that are reflected by the non-distance-measurement object, and wherein the non-object histogram is lower than the object histogram as a whole and has a flat shape.
